(19) United States
(12) Patent Application Publication
(10) Pub. No.: US 2020/0104803 A1
(43) Pub. Date: Apr. 2, 2020

(54) AUTOMATED SCHEDULING OF APPOINTMENTS USING PLACEHOLDERS

(71) Applicant: TimeTrade Systems, Inc., Tewksbury, MA (US)

(72) Inventor: Mukul Goyal, Tewksbury, MA (US)

(21) Appl. No.: 16/561,424

(22) Filed: Sep. 5, 2019

Related U.S. Application Data
(60) Provisional application No. 62/737,306, filed on Sep. 27, 2018.

(51) Int. Cl. G06Q 10/10

(52) U.S. Cl. CPC G06Q 10/1095; G06Q 10/107

(57) ABSTRACT

In one example, a server inserts placeholders on a first subset of a plurality of time slots. Based on availability information for respective meeting attendees, the server determines whether a second subset of the plurality of time slots includes unique time slots for the respective meeting attendees during which the respective meeting attendees are available. If not, the server removes the placeholders from the first subset and inserts the placeholders on a third subset of the plurality of time slots. Based on the availability information, the server determines whether a fourth subset of the plurality of time slots includes the unique time slots. If so, the server causes respective meeting invitations corresponding to the unique time slots to be sent to the respective meeting attendees.

### CROSS REFERENCE TO RELATED APPLICATION

This application claims the benefit of U.S. Provisional Application No. 62/737,306 filed Sep. 27, 2018, the entirety of which is incorporated herein by reference.

### TECHNICAL FIELD

The present disclosure relates to automated appointment scheduling.

### BACKGROUND

Professionals throughout various industries often spend excess time and resources manually organizing meetings with colleagues and/or customers via standard communication channels such as email, text, within a Customer Relationship Management (CRM) application, social media, etc. This is inefficient and negatively impacts productivity.

### BRIEF DESCRIPTION OF THE DRAWINGS

FIG. 1 illustrates a system configured for automated scheduling of appointments using placeholders, according to an example embodiment.

FIG. 2A illustrates a table showing availability information of meeting attendees at time slots that do not have placeholders, according to an example embodiment.

FIG. 2B illustrates a bipartite graph reflecting the availability information shown in FIG. 2A, according to an example embodiment.

FIG. 3A illustrates another table showing availability information of meeting attendees at time slots that do not have placeholders, according to an example embodiment.

FIG. 3B illustrates a bipartite graph reflecting the availability information shown in FIG. 3A, according to an example embodiment.

FIG. 4 illustrates a block diagram of a computing device configured for automated scheduling of appointments using placeholders, according to an example embodiment.

FIG. 5 illustrates a flowchart of a method for automated scheduling of appointments using placeholders, according to an example embodiment.

### DESCRIPTION OF EXAMPLE EMBODIMENTS

### Overview

In one example embodiment, a server obtains availability information for respective meeting attendees. The availability information indicates when the respective meeting attendees are available during a plurality of time slots including a first subset of the plurality of time slots, a second subset of the plurality of time slots, a third subset of the plurality of time slots, and a fourth subset of the plurality of time slots. The server inserts placeholders on the first subset. Based on the availability information, the server determines whether the second subset includes unique time slots for the respective meeting attendees during which the respective meeting attendees are available. If it is determined that the second subset does not include the unique time slots, the server removes the placeholders from the first subset. The server inserts the placeholders on the third subset. Based on the availability information, the server determines whether the fourth subset includes the unique time slots. If it is determined that the fourth subset of the plurality of time slots includes the unique time slots, the server causes respective meeting invitations corresponding to the unique time slots to be sent to the respective meeting attendees.

### Example Embodiments

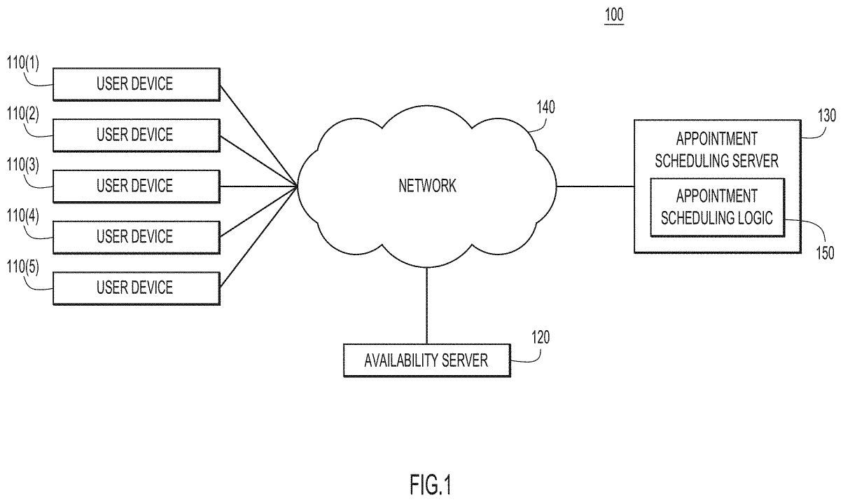

FIG. 1 illustrates an example system 100 configured for automated scheduling of appointments using placeholders. The system includes user devices 110(1)-110(5), availability server 120, and appointment scheduling server 130. System 100 also includes network 140 which enables communications between user devices 110(1)-110(5), availability server 120, and appointment scheduling server 130. Network 140 may be an enterprise network, and each user device 110(1)-110(5) may be associated with a meeting attendee (e.g., an employee of the enterprise, such as entry-level, manager, executive, etc.). The employees may provide indications of their availabilities/calendars to user devices 110(1)-110(5), which may in turn provide that information to availability server 120. Availability server 120 may maintain availability information for each employee.

In one example, each of the five employees associated with user devices 110(1)-110(5) is to meet with a job candidate at the enterprise site for an individual thirty-minute interview (the order of the interviews is irrelevant). The job candidate is available to be on-premise from noon to 5:00 pm, although it would be inconvenient to require the job candidate to remain on-premise for an unnecessary amount of time. That is, because the job candidate is traveling on-premise for the interviews, it is desirable for the interviews to be scheduled sequentially (e.g., back-to-back). Conventionally, the employees would need to manually arrange times for the interviews. This is a complex problem, and may require many iterations, communications (e.g., email messages), and rescheduling events. This manual process wastes valuable computing and other network resources (e.g., memory, processors, bandwidth, etc.). The problem of wasted network resources is exacerbated as the number of employees who need to be scheduled increases.

Accordingly, in order to improve the functioning of system 100 (e.g., network 140), appointment scheduling logic 150 is integrated in appointment scheduling server 130. Briefly, appointment scheduling logic 150 causes appointment scheduling server 130 to perform smart appointment sequencing operations described herein. Appointment scheduling server 130 improves the efficiency of system 100 while resolving the aforementioned complex interview scheduling problem by automatically scheduling appointments using placeholders.

Appointment scheduling server 130 may obtain (e.g., from availability server 120), availability information of each of the five employees. The availability information may indicate when the respective meeting attendees are available during time slots between noon and 5:00 pm. In this example, because each interview is thirty minutes, there are a total of ten possible time slots between noon and 5:00 pm for each of the five employees (e.g., 12:00 pm-12:30 pm; 12:30 pm-1:00 pm; etc.). Here, the time slots include a first subset (e.g., the last five time slots between noon and 5:00 pm) and a second subset (e.g., the first five time slots between noon and 5:00 pm).

Appointment scheduling server 130 may insert placeholders (e.g., rotating blockers) over the first subset (e.g., the last five time slots between noon and 5:00 pm). The placeholders may preclude appointment scheduling server 130 from considering the first subset as part of a possible solution (configuration of time slots). This leaves the first five possible time slots available for the individual interviews. The number of placeholders may be chosen such that the number of employees (five) is equal to the number of time slots in the second subset (five) to allow for calculation of outputs with a unique time slot for each employee. The placement of the placeholders may ensure that the time slots in the first subset are back-to-back.

Based on the availability information, appointment scheduling server 130 may determine whether the second subset (e.g., the first five time slots between noon and 5:00 pm) includes unique time slots for the respective employees during which the respective employees are available. In other words, appointment scheduling server 130 may determine whether it is possible to schedule one employee per time slot in the second subset. If it is determined that the second subset includes unique time slots for the respective employees during which the respective employees are available, appointment scheduling server 130 may cause respective meeting invitations corresponding to the unique time slots to be sent to the respective employees. In one example, appointment scheduling server 130 automatically sends (or causes another entity, such as availability server 120, to send) respective meeting invitations to each user device 110(1)-110(5) and, optionally, one or more meeting invitations to a user device of the job candidate. In a further example, if there is more than one possible solution (configuration of time slots), the job candidate may be presented with an interface that enables the job candidate to select one of a number of possible solutions for scheduling.

The plurality of time slots further includes third and fourth subsets of the plurality of time slots. For example, the third subset may include the last four time slots between noon and 5:00 pm and the first time slot between noon and 5:00 pm, and the fourth subset may include the remaining time slots between noon and 5:00 pm. If it is determined that the second subset does not include unique time slots for the respective employees during which the respective employees are available, appointment scheduling server 130 may remove the placeholders from the first subset and insert the placeholders on the third subset. In other words, appointment scheduling server 130 rotates the placeholders forward by one time slot. In this example, the last placeholder falls outside the noon to 5:00 pm range, and is therefore rotated to the first possible time slot beginning at noon.

Based on the availability information, appointment scheduling server 130 may determine whether the fourth subset includes unique time slots for the respective employees during which the respective employees are available. If it is determined that the fourth subset includes unique time slots for the respective employees during which the respective employees are available, appointment scheduling server 130 may cause respective meeting invitations corresponding to the unique time slots to be sent to the respective employees. If it is determined that the fourth subset does not include unique time slots for the respective employees during which the respective employees are available, appointment scheduling server 130 may continue iteratively rotating the placeholders forward until a suitable output/solution is discovered.

The example described in connection with FIG. 1 involves iterative forward rotation. In this example, appointment scheduling server 130 may remove a placeholder from a time slot of the first subset (e.g., the last five time slots between noon and 5:00 pm). The time slot may occur earlier than any other time slot of the first subset (here, 2:30 pm-3:00 pm). Appointment scheduling server 130 may insert a placeholder on a time slot of the third subset (e.g., the last four time slots between noon and 5:00 pm and the first time slot between noon and 5:00 pm). The time slot may occur later than any other time slot of the first subset or, if the time slot cannot occur later than any other time slot of the first subset, the time slot may occur earlier than any other time slot of the first subset. In other words, the placeholders may “wrap around” to the first time slot. In this case, the time slot cannot occur later than any other time slot of the first subset, because the latest time slot of the first subset is 4:30 pm-5:00 pm. As such, the time slot occurs earlier than any other time slot of the first subset (here, 12:00 pm-12:30 pm).

It will be appreciated that iterative backward rotation may also/alternatively be employed. In this example, appointment scheduling server 130 may remove a placeholder from a time slot of the first subset (e.g., the last five time slots between noon and 5:00 pm). The time slot may occur later than any other time slot of the first subset (here, 4:30 pm-5:00 pm). Appointment scheduling server 130 may insert a placeholder on a time slot of the third subset (e.g., the penultimate five time slots between noon and 5:00 pm). The time slot may occur earlier than any other time slot of the first subset. In this case, the time slot occurs at 2:00 pm-2:30 pm. If the time slot cannot occur earlier than any other time slot of the first subset (e.g., if the first subset includes the first five time slots between noon and 5:00 pm), the time slot may occur later than any other time slot of the first subset (e.g., 4:30 pm-5:00 pm). In other words, the placeholders may “wrap around” to the last time slot.

Appointment scheduling server 130 may rearrange the placeholders in any suitable manner. In one example, appointment scheduling server 130 may utilize forward and/or backward iterative rotation as discussed above. In another example, appointment scheduling server 130 may rearrange placeholders disjointedly (e.g., the placeholders may initially be placed in the last several time slots, and may then move to the first several time slots). Furthermore, it will be appreciated that techniques described herein may apply to any suitable number of meeting attendees and/or time slots. Moreover, placeholders may be placed at any suitable initial position (e.g., the first time slot, the second time slot, etc.). Although the aforementioned example involves searching for sequential (back-to-back) appointment solutions, in other examples the appointment scheduling server may search for non-sequential appointment solutions.

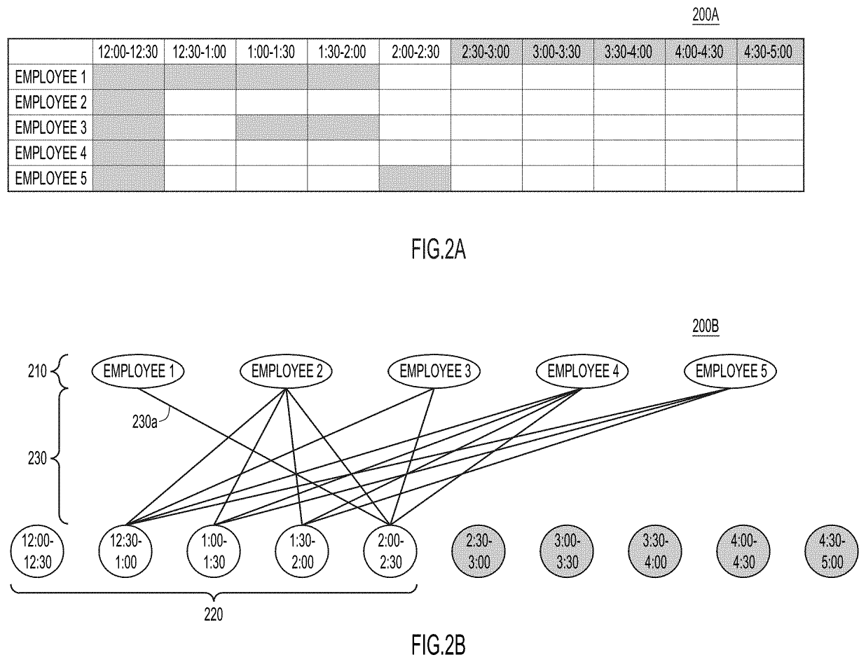

FIG. 2A illustrates an example table 200A showing the availability information of the five employees at time slots that do not have placeholders. Time slots between 2:30 pm and 5:00 pm are greyed out, indicating that appointment scheduling server 130 has inserted placeholders for those time slots. Availability information is shown for the time slots between noon and 2:30 pm, which do not have placeholders. These time slots are greyed out where an individual employee has no availability (e.g., has a previously scheduled meeting).

FIG. 2B illustrates an example bipartite graph 200B reflecting the availability information shown in table 200A. Bipartite graph 200B includes set of vertices 210, set of vertices 220, and edges 230. Set of vertices 210 corresponds to the employees and set of vertices 220 corresponds to the second subset of the plurality of time slots. Each edge of edges 230 connects a respective vertex of set of vertices 210 and a respective vertex of set of vertices 220. A respective vertex of set of vertices 210 corresponds to a given employee, and a respective vertex of set of vertices 220 corresponds to a given time slot of the second subset. Each edge of edges 230 indicates an availability of the given meeting attendee during the given time slot.

For example, edge 230a connects the vertex corresponding to Employee 1 and the vertex corresponding to time slot 2:00 pm-2:30 pm, indicating that Employee 1 is available during the 2:00 pm-2:30 pm time slot. Conversely, there is no edge connecting the vertex corresponding to Employee 1 and the vertex corresponding to time slot 12:00-12:30, indicating that Employee 1 is not available during the 12:00-12:30 time slot. The time slots with placeholders are greyed out, and have no connecting edges. That is, appointment scheduling server 130 does not provide any edges connecting time slots that have a placeholder, even if there are employees who are available at those time slots.

Appointment scheduling server 130 may determine whether the first subset includes unique time slots for the respective employees during which the respective employees are available by generating bipartite graph 200B. Appointment scheduling server 130 may, for example, apply the Hoperoft-Karp algorithm to determine whether there is any output that will yield a unique time slot for every employee. The Hoperoft-Karp algorithm may provide an output of a set of as many edges as possible without any two edges sharing an endpoint.

In the example of FIGS. 2A and 2B, there is no solution where the employees can hold respective interviews during the time slots between noon and 2:30. This is because none of the employees are available during the 12:00 pm-12:30 pm time slot, which would leave only four other time slots for five employees. As such, appointment scheduling server 130 determines that the second subset does not include unique time slots for the respective employees during which the respective employees are available, and may proceed to rotate the placeholders accordingly.

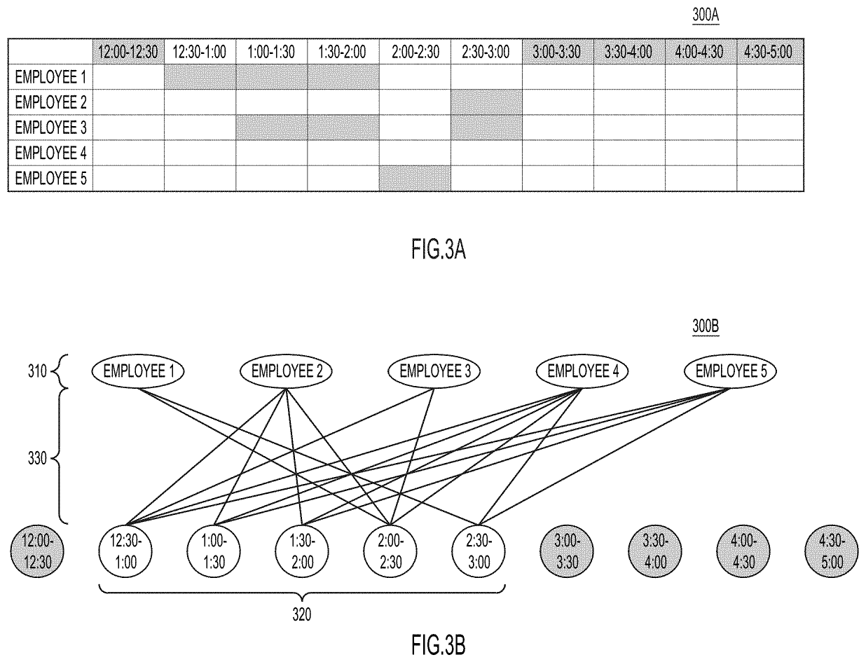

FIG. 3A illustrates an example table 300A showing the availability information of the five employees at time slots that do not have the rotated placeholders. As shown, the placeholders have been rotated forward such that the 2:30 pm-3:00 pm time slot now has no placeholder and the 12:00 pm-12:30 pm time slot now has a placeholder. Time slots between 3:00 pm and 5:00 pm, as well as time slot 12:00 pm-12:30 pm, are greyed out, indicating that appointment scheduling server 130 has inserted placeholders for those time slots. Availability information is shown for the time slots between 12:30 pm and 3:00 pm, which do not have placeholders. These time slots are greyed out where an individual employee has no availability (e.g., has a previously scheduled meeting).

FIG. 3B illustrates an example bipartite graph 300B reflecting the availability information shown in table 300A. Bipartite graph 300B includes set of vertices 310, set of vertices 320, and edges 330. Set of vertices 310 corresponds to the employees and set of vertices 320 corresponds to the fourth subset of the plurality of time slots. Each edge of edges 330 connects a respective vertex of set of vertices 310 and a respective vertex of set of vertices 320. A respective vertex of set of vertices 310 corresponds to a given employee, and a respective vertex of set of vertices 320 corresponds to a given time slot of the second subset. Each edge of edges 330 indicates an availability of the given meeting attendee during the given time slot.

Appointment scheduling server 130 may determine whether the first subset of includes unique time slots for the respective employees during which the respective employees are available by generating bipartite graph 300B. Appointment scheduling server 130 may, for example, apply the Hoperoft-Karp algorithm to determine whether there is any output that will yield a unique time slot for every employee. In this example, appointment scheduling server 130 determines an output from the Hoperoft-Karp algorithm that yields a unique time slot for every employee. That is, there is at least one solution where respective employees hold respective interviews during the time slots between 12:30 pm and 3:00 pm. One example solution is to schedule Employee 2 at the 12:30 pm-1:00 pm time slot, Employee 4 at the 1:00 pm-1:30 pm time slot, Employee 5 at the 1:30 pm-2:00 pm time slot, Employee 3 at the 2:00 pm-2:30 pm time slot, and Employee 1 at the 2:30 pm-3:00 pm time slot. Appointment scheduling server 130 may send out (or cause to be sent out) respective meeting invitations to the employees at those meeting times.

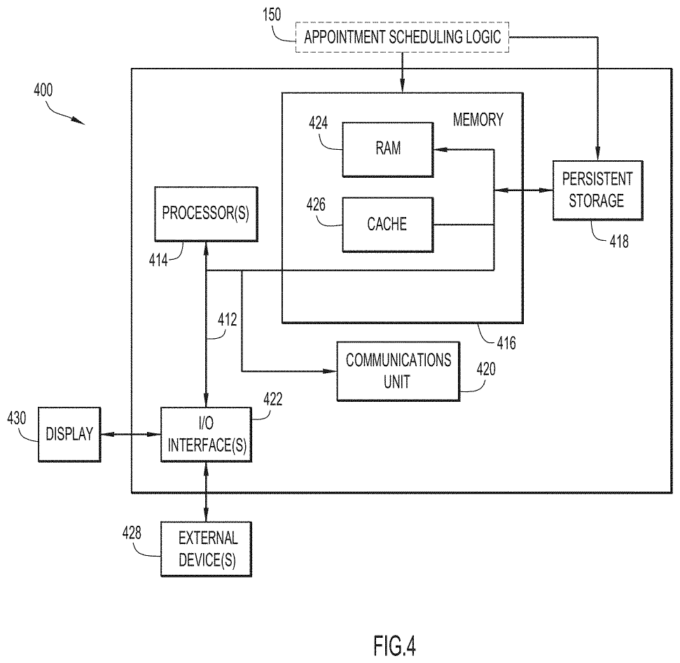

FIG. 4 illustrates a hardware block diagram of a device 400 (e.g., a computing device) that may perform the functions of any of the servers or computing or control entities referred to herein in connection with appointment scheduling. It should be appreciated that FIG. 4 provides only an illustration of one embodiment and does not imply any limitations with regard to the environments in which different embodiments may be implemented. Many modifications to the depicted environment may be made.

As depicted, the device 400 includes a bus 412, which provides communications between computer processor(s) 414, memory 416, persistent storage 418, communications unit 420, and Input/Output (I/O) interface(s) 422. Bus 412 can be implemented with any architecture designed for passing data and/or control information between processors (such as microprocessors, communications and network processors, etc.), system memory, peripheral devices, and any other hardware components within a system. For example, bus 412 can be implemented with one or more buses.

Memory 416 and persistent storage 418 are computer readable storage media. In the depicted embodiment, memory 416 includes Random Access Memory (RAM) 424 and cache memory 426. In general, memory 416 can include any suitable volatile or non-volatile computer readable storage media. Instructions for appointment scheduling logic 150 may be stored in memory 416 or persistent storage 418 for execution by processor(s) 414.

One or more programs may be stored in persistent storage 418 for execution by one or more respective computer processors 414 via one or more memories of memory 416. The persistent storage 418 may be a magnetic hard disk drive, a solid state hard drive, a semiconductor storage device, Read-Only Memory (ROM), Erasable Programmable Read-Only Memory (EPROM), flash memory, or any other computer readable storage media that is capable of storing program instructions or digital information.

The media used by persistent storage 418 may also be removable. For example, a removable hard drive may be used for persistent storage 418. Other examples include optical and magnetic disks, thumb drives, and smart cards that are inserted into a drive for transfer onto another computer readable storage medium that is also part of persistent storage 418.

Communications unit 420, in these examples, provides for communications with other data processing systems or devices. In these examples, communications unit 420 includes one or more network interface cards. Communications unit 420 may provide communications through the use of either or both physical and wireless communications links.

I/O interface(s) 422 allows for input and output of data with other devices that may be connected to device 400. For example, I/O interface(s) 422 may provide a connection to external devices 428 such as a keyboard, keypad, a touch screen, and/or some other suitable input device. External devices 428 can also include portable computer readable storage media such as database systems, thumb drives, portable optical or magnetic disks, and memory cards.

Software and data used to practice embodiments can be stored on such portable computer readable storage media and can be loaded onto persistent storage 418 via I/O interface(s) 422. I/O interface(s) 422 may also connect to a display 430. Display 430 provides a mechanism to display data to a user and may be, for example, a computer monitor.

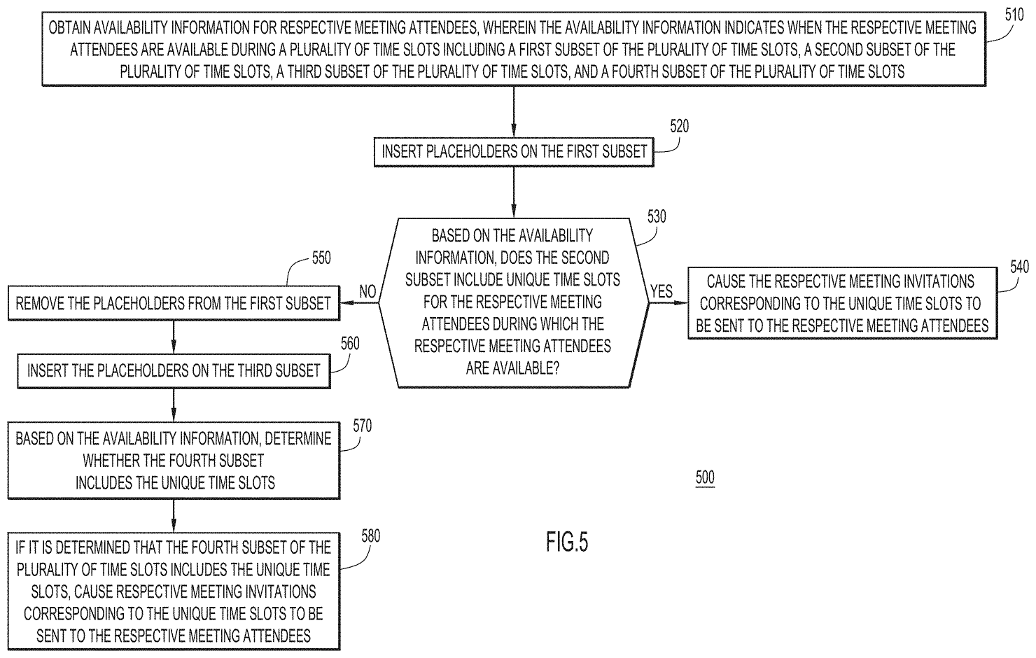

FIG. 5 is a flowchart of an example method 500 for automated scheduling of appointments using placeholders. In this example, appointment scheduling server 130 performs method 500, although it will be appreciated that method 500 may be performed by one or multiple servers/user devices. It will be further appreciated that appointment scheduling server 130 may perform additional functions/operations, such as those associated with availability server 120.

At 510, appointment scheduling server 130 obtains availability information for respective meeting attendees. The availability information indicates when the respective meeting attendees are available during a plurality of time slots including a first subset of the plurality of time slots, a second subset of the plurality of time slots, a third subset of the plurality of time slots, and a fourth subset of the plurality of time slots. At 520, appointment scheduling server 130 inserts placeholders on the first subset. At 530, based on the availability information, appointment scheduling server 130 determines whether the second subset includes unique time slots for the respective meeting attendees during which the respective meeting attendees are available. At 540, if it is determined that the second subset of the plurality of time slots includes the unique time slots, appointment scheduling server 130 causes the respective meeting invitations corresponding to the unique time slots to be sent to the respective meeting attendees.

At 550, if it is determined that the second subset does not include the unique time slots, appointment scheduling server 130 removes the placeholders from the first subset. At 560, appointment scheduling server 130 inserts the placeholders on the third subset. At 570, based on the availability information, appointment scheduling server 130 determines whether the fourth subset includes the unique time slots. At 580, if it is determined that the fourth subset of the plurality of time slots includes the unique time slots, appointment scheduling server 130 causes respective meeting invitations corresponding to the unique time slots to be sent to the respective meeting attendees.

The programs described herein are identified based upon the application for which they are implemented in a specific embodiment. However, it should be appreciated that any particular program nomenclature herein is used merely for convenience, and thus the embodiments should not be limited to use solely in any specific application identified and/or implied by such nomenclature.

Data relating to operations described herein may be stored within any conventional or other data structures (e.g., files, arrays, lists, stacks, queues, records, etc.) and may be stored in any desired storage unit (e.g., database, data or other repositories, queue, etc.). The data transmitted between entities may include any desired format and arrangement, and may include any quantity of any types of fields of any size to store the data. The definition and data model for any datasets may indicate the overall structure in any desired fashion (e.g., computer-related languages, graphical representation, listing, etc.).

The present embodiments may employ any number of any type of user interface (e.g., Graphical User Interface (GUI), command-line, prompt, etc.) for obtaining or providing information, where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The environment of the present embodiments may include any number of computer or other processing systems (e.g., client or end-user systems, server systems, etc.) and databases or other repositories arranged in any desired fashion, where the present embodiments may be applied to any desired type of computing environment (e.g., cloud computing, client-server, network computing, mainframe, stand-alone systems, etc.). The computer or other processing systems employed by the present embodiments may be implemented by any number of any personal or other type of computer or processing system (e.g., desktop, laptop, Personal Digital Assistant (PDA), mobile devices, etc.), and may include any commercially available operating system and any combination of commercially available and custom software (e.g., machine learning software, etc.). These systems may include any types of monitors and input devices (e.g., keyboard, mouse, voice recognition, etc.) to enter and/or view information.

It is to be understood that the software of the present embodiments may be implemented in any desired computer language and could be developed by one of ordinary skill in the computer arts based on the functional descriptions contained in the specification and flow charts illustrated in the drawings. Further, any references herein of software performing various functions generally refer to computer systems or processors performing those functions under software control. The computer systems of the present embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., Local Area Network (LAN), Wide Area Network (WAN), Intranet, Internet, hardwire, modem connection, wireless, etc.). For example, the functions of the present embodiments may be distributed in any manner among the various end-user/client and server systems, and/or any other intermediary processing devices. The software and/or algorithms described above and illustrated in the flow charts may be modified in any manner that accomplishes the functions described herein. In addition, the functions in the flow charts or description may be performed in any order that accomplishes a desired operation.

The software of the present embodiments may be available on a non-transitory computer useable medium (e.g., magnetic or optical mediums, magneto-optic mediums, floppy diskettes, Compact Disc ROM (CD-ROM), Digital Versatile Disk (DVD), memory devices, etc.) of a stationary or portable program product apparatus or device for use with stand-alone systems or systems connected by a network or other communications medium.

The communication network may be implemented by any number of any type of communications network (e.g., LAN, WAN, Internet, Intranet, Virtual Private Network (VPN), etc.). The computer or other processing systems of the present embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information. The database system may be implemented by any number of any conventional or other databases, data stores or storage structures (e.g., files, databases, data structures, data or other repositories, etc.) to store information. The database system may be included within or coupled to the server and/or client systems. The database systems and/or storage structures may be remote from or local to the computer or other processing systems, and may store any desired data.

The embodiments presented may be in various forms, such as a system, a method, and/or a computer program product at any possible technical detail level of integration. The computer program product may include a computer readable storage medium (or media) having computer readable program instructions thereon for causing a processor to carry out aspects of presented herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, EPROM, Flash memory, a Static RAM (SRAM), a portable CD-ROM, a DVD, a memory stick, a floppy disk, a mechanically encoded device, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiments may be assembler instructions, Instruction-Set-Architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Python, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some embodiments, electronic circuitry including, for example, programmable logic circuitry, Field-Programmable Gate Arrays (FPGA), or Programmable Logic Arrays (PLA) may execute the computer readable program instructions by utilizing state information of the computer readable program instructions to personalize the electronic circuitry, in order to perform aspects presented herein.

Aspects of the present embodiments are described herein with reference to flowchart illustrations and/or block diagrams of methods, apparatus (systems), and computer program products according to the embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In one form, a method is provided. The method comprises: obtaining availability information for respective meeting attendees, wherein the availability information indicates when the respective meeting attendees are available during a plurality of time slots including a first subset of the plurality of time slots, a second subset of the plurality of time slots, a third subset of the plurality of time slots, and a fourth subset of the plurality of time slots; inserting placeholders on the first subset; based on the availability information, determining whether the second subset includes unique time slots for the respective meeting attendees during which the respective meeting attendees are available; and if it is determined that the second subset does not include the unique time slots: removing the placeholders from the first subset; inserting the placeholders on the third subset; based on the availability information, determining whether the fourth subset includes the unique time slots; and if it is determined that the fourth subset of the plurality of time slots includes the unique time slots, causing respective meeting invitations corresponding to the unique time slots to be sent to the respective meeting attendees.

In one example, the method further comprises: if it is determined that the second subset of the plurality of time slots includes the unique time slots, causing the respective meeting invitations corresponding to the unique time slots to be sent to the respective meeting attendees.

In one example, removing the placeholders from the first subset includes removing a first placeholder of the placeholders from a first time slot of the first subset, wherein the first time slot occurs earlier than any other time slot of the first subset; and inserting the placeholders on the third subset includes inserting a second placeholder of the placeholders on a second time slot of the third subset, wherein the second time slot occurs later than any other time slot of the first subset or, if the second time slot cannot occur later than any other time slot of the first subset, the second time slot occurs earlier than any other time slot of the first subset.

In one example, removing the placeholders from the first subset includes removing a first placeholder of the placeholders from a first time slot of the first subset, wherein the first time slot occurs later than any other time slot of the first subset; and inserting the placeholders on the third subset includes inserting a second placeholder of the placeholders on a second time slot of the third subset, wherein the second time slot occurs earlier than any other time slot of the first subset or, if the second time slot cannot occur earlier than any other time slot of the first subset, the second time slot occurs later than any other time slot of the first subset.

In one example, determining whether the first subset of the plurality of time slots includes the unique time slots for the respective meeting attendees during which the respective meeting attendees are available includes: generating a bipartite graph including a first set of vertices corresponding to the respective meeting attendees, a second set of vertices corresponding to the second subset, and one or more edges, each edge of the one or more edges connecting a respective vertex of the first set of vertices and a respective vertex of the second set of vertices, wherein the respective vertex of the first set of vertices corresponds to a given meeting attendee of the respective meeting attendees and the respective vertex of the second set of vertices corresponds to a given time slot of the second subset, and wherein each edge indicates an availability of the given meeting attendee during the given time slot.

In one example, a number of the respective meeting attendees is equal to a number of time slots in the second subset.

In one example, the second subset of the plurality of time slots include back-to-back time slots.

In another form, an apparatus is provided. The apparatus comprises: a network interface configured to send/receive network communications; and one or more processors coupled to the network interface, wherein the one or more processors are configured to: obtain availability information for respective meeting attendees, wherein the availability information indicates when the respective meeting attendees are available during a plurality of time slots including a first subset of the plurality of time slots, a second subset of the plurality of time slots, a third subset of the plurality of time slots, and a fourth subset of the plurality of time slots; insert placeholders on the first subset; based on the availability information, determine whether the second subset includes unique time slots for the respective meeting attendees during which the respective meeting attendees are available; and if it is determined that the second subset does not include the unique time slots: remove the placeholders from the first subset; insert the placeholders on the third subset; based on the availability information, determine whether the fourth subset includes the unique time slots; and if it is determined that the fourth subset of the plurality of time slots includes the unique time slots, cause respective meeting invitations corresponding to the unique time slots to be sent to the respective meeting attendees.

In another form, one or more non-transitory computer readable storage media are provided. The non-transitory computer readable storage media are encoded with instructions that, when executed by a processor, cause the processor to: obtain availability information for respective meeting attendees, wherein the availability information indicates when the respective meeting attendees are available during a plurality of time slots including a first subset of the plurality of time slots, a second subset of the plurality of time slots, a third subset of the plurality of time slots, and a fourth subset of the plurality of time slots; insert placeholders on the first subset; based on the availability information, determine whether the second subset includes unique time slots for the respective meeting attendees during which the respective meeting attendees are available; and if it is determined that the second subset does not include the unique time slots: remove the placeholders from the first subset; insert the placeholders on the third subset; based on the availability information, determine whether the fourth subset includes the unique time slots; and if it is determined that the fourth subset of the plurality of time slots includes the unique time slots, cause respective meeting invitations corresponding to the unique time slots to be sent to the respective meeting attendees.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
obtaining availability information for respective meeting attendees, wherein the availability information indicates when the respective meeting attendees are available during a plurality of time slots including a first subset of the plurality of time slots, a second subset of the plurality of time slots, a third subset of the plurality of time slots and a fourth subset of the plurality of time slots;
inserting placeholders on the first subset;
based on the availability information, determining whether the second subset includes unique time slots for the respective meeting attendees during which the respective meeting attendees are available; and
if it is determined that the second subset does not include the unique time slots:
removing the placeholders from the first subset;
inserting the placeholders on the third subset;
based on the availability information, determining whether the fourth subset includes the unique time slots; and
if it is determined that the fourth subset of the plurality of time slots includes the unique time slots, causing respective meeting invitations corresponding to the unique time slots to be sent to the respective meeting attendees.

2. The method of claim 1, further comprising:
if it is determined that the second subset of the plurality of time slots includes the unique time slots, causing the respective meeting invitations corresponding to the unique time slots to be sent to the respective meeting attendees.

3. The method of claim 1, wherein:
removing the placeholders from the first subset includes removing a first placeholder of the placeholders from a first time slot of the first subset, wherein the first time slot occurs earlier than any other time slot of the first subset; and
inserting the placeholders on the third subset includes inserting a second placeholder of the placeholders on a second time slot of the third subset, wherein the second time slot occurs later than any other time slot of the first subset or, if the second time slot cannot occur later than any other time slot of the first subset, the second time slot occurs earlier than any other time slot of the first subset.

4. The method of claim 1, wherein:
removing the placeholders from the first subset includes removing a first placeholder of the placeholders from a first time slot of the first subset, wherein the first time slot occurs later than any other time slot of the first subset; and
inserting the placeholders on the third subset includes inserting a second placeholder of the placeholders on a second time slot of the third subset, wherein the second time slot occurs earlier than any other time slot of the first subset or, if the second time slot cannot occur earlier than any other time slot of the first subset, the second time slot occurs later than any other time slot of the first subset.

5. The method of claim 1, wherein determining whether the first subset of the plurality of time slots includes the unique time slots for the respective meeting attendees during which the respective meeting attendees are available includes:
generating a bipartite graph including a first set of vertices corresponding to the respective meeting attendees, a second set of vertices corresponding to the second subset, and one or more edges, each edge of the one or more edges connecting a respective vertex of the first set of vertices and a respective vertex of the second set of vertices, wherein the respective vertex of the first set of vertices corresponds to a given meeting attendee of the respective meeting attendees and the respective vertex of the second set of vertices corresponds to a given time slot of the second subset, and wherein each edge indicates an availability of the given meeting attendee during the given time slot.

6. The method of claim 1, wherein a number of the respective meeting attendees is equal to a number of time slots in the second subset.

7. The method of claim 1, wherein the second subset of the plurality of time slots include back-to-back time slots.

8. An apparatus comprising:
a network interface configured to send/receive network communications; and
one or more processors coupled to the network interface, wherein the one or more processors are configured to:
obtain availability information for respective meeting attendees, wherein the availability information indicates when the respective meeting attendees are available during a plurality of time slots including a first subset of the plurality of time slots, a second subset of the plurality of time slots, a third subset of the plurality of time slots, and a fourth subset of the plurality of time slots;
insert placeholders on the first subset;
based on the availability information, determine whether the second subset includes unique time slots for the respective meeting attendees during which the respective meeting attendees are available; and
if it is determined that the second subset does not include the unique time slots:
remove the placeholders from the first subset;
insert the placeholders on the third subset;
based on the availability information, determine whether the fourth subset includes the unique time slots; and
if it is determined that the fourth subset of the plurality of time slots includes the unique time slots, cause respective meeting invitations corresponding to the unique time slots to be sent to the respective meeting attendees.

9. The apparatus of claim 8, wherein the one or more processors are further configured to:
if it is determined that the second subset of the plurality of time slots includes the unique time slots, cause the respective meeting invitations corresponding to the unique time slots to be sent to the respective meeting attendees.

10. The apparatus of claim 8, wherein the one or more processors are further configured to:
remove a first placeholder of the placeholders from a first time slot of the first subset, wherein the first time slot occurs earlier than any other time slot of the first subset; and
insert a second placeholder of the placeholders on a second time slot of the third subset, wherein the second time slot occurs later than any other time slot of the first subset or, if the second time slot cannot occur later than any other time slot of the first subset, the second time slot occurs earlier than any other time slot of the first subset.

11. The apparatus of claim 8, wherein the one or more processors are further configured to:
remove a first placeholder of the placeholders from a first time slot of the first subset, wherein the first time slot occurs later than any other time slot of the first subset; and
insert a second placeholder of the placeholders on a second time slot of the third subset, wherein the second time slot occurs earlier than any other time slot of the first subset or, if the second time slot cannot occur earlier than any other time slot of the first subset, the second time slot occurs later than any other time slot of the first subset.

12. The apparatus of claim 8, wherein the one or more processors are further configured to:
generate a bipartite graph including a first set of vertices corresponding to the respective meeting attendees, a second set of vertices corresponding to the second subset, and one or more edges, each edge of the one or more edges connecting a respective vertex of the first set of vertices and a respective vertex of the second set of vertices, wherein the respective vertex of the first set of vertices corresponds to a given meeting attendee of the respective meeting attendees and the respective vertex of the second set of vertices corresponds to a given time slot of the second subset, and wherein each edge indicates an availability of the given meeting attendee during the given time slot.

13. The apparatus of claim 8, wherein a number of the respective meeting attendees is equal to a number of time slots in the second subset.

14. The apparatus of claim 8, wherein the second subset of the plurality of time slots include back-to-back time slots.

15. One or more non-transitory computer readable storage media encoded with instructions that, when executed by a processor, cause the processor to:
obtain availability information for respective meeting attendees, wherein the availability information indicates when the respective meeting attendees are available during a plurality of time slots including a first subset of the plurality of time slots, a second subset of the plurality of time slots, a third subset of the plurality of time slots, and a fourth subset of the plurality of time slots;
insert placeholders on the first subset;
based on the availability information, determine whether the second subset includes unique time slots for the respective meeting attendees during which the respective meeting attendees are available; and
if it is determined that the second subset does not include the unique time slots:
remove the placeholders from the first subset;
insert the placeholders on the third subset;
based on the availability information, determine whether the fourth subset includes the unique time slots; and
if it is determined that the fourth subset of the plurality of time slots includes the unique time slots, cause respective meeting invitations corresponding to the unique time slots to be sent to the respective meeting attendees.

16. The one or more non-transitory computer readable storage media of claim 15, wherein the instructions further cause the processor to:
if it is determined that the second subset of the plurality of time slots includes the unique time slots, cause the respective meeting invitations corresponding to the unique time slots to be sent to the respective meeting attendees.

17. The one or more non-transitory computer readable storage media of claim 15, wherein the instructions further cause the processor to:
remove a first placeholder of the placeholders from a first time slot of the first subset, wherein the first time slot occurs earlier than any other time slot of the first subset; and
insert a second placeholder of the placeholders on a second time slot of the third subset, wherein the second time slot occurs later than any other time slot of the first subset or, if the second time slot cannot occur later than any other time slot of the first subset, the second time slot occurs earlier than any other time slot of the first subset.

18. The one or more non-transitory computer readable storage media of claim 15, wherein the instructions further cause the processor to:
remove a first placeholder of the placeholders from a first time slot of the first subset, wherein the first time slot occurs later than any other time slot of the first subset; and
insert a second placeholder of the placeholders on a second time slot of the third subset, wherein the second time slot occurs earlier than any other time slot of the first subset or, if the second time slot cannot occur earlier than any other time slot of the first subset, the second time slot occurs later than any other time slot of the first subset.

19. The one or more non-transitory computer readable storage media of claim 15, wherein the instructions further cause the processor to:
generate a bipartite graph including a first set of vertices corresponding to the respective meeting attendees, a second set of vertices corresponding to the second subset, and one or more edges, each edge of the one or more edges connecting a respective vertex of the first set of vertices and a respective vertex of the second set of vertices, wherein the respective vertex of the first set of vertices corresponds to a given meeting attendee of the respective meeting attendees and the respective vertex of the second set of vertices corresponds to a given time slot of the second subset, and wherein each edge indicates an availability of the given meeting attendee during the given time slot.

20. The one or more non-transitory computer readable storage media of claim 15, wherein a number of the respective meeting attendees is equal to a number of time slots in the second sub set.
